(19) United States
(12) Patent Application Publication
(10) Pub. No.: US 2025/0007049 A1
(43) Pub. Date: Jan. 2, 2025

(54) LAMINATED BATTERY AND METHOD OF PRODUCING LAMINATED BATTERY

(71) Applicant: TOYOTA JIDOSHA KABUSHIKI KAISHA, Toyota-shi (JP)

(72) Inventors: Kenichi KAKISHITA, Nagoya-shi (JP); Sumiko KITO, Nagoya-shi (JP)

(73) Assignee: TOYOTA JIDOSHA KABUSHIKI KAISHA, Toyota-shi (JP)

(21) Appl. No.: 18/653,647

(22) Filed: May 2, 2024

(30) Foreign Application Priority Data
Jun. 30, 2023 (JP) 2023-108903

(51) Int. Cl. H01M 50/105; H01M 50/129

(52) U.S. Cl. CPC H01M 50/105; H01M 50/129

(57) ABSTRACT

A laminated battery includes: an electrode body; and a laminate film package that covers the electrode body and encloses the electrode body therein. In the laminated battery, the laminate film package includes a first laminate film portion and a second laminate film portion, and the laminate film package has a fused part at which an end part of the first laminate film portion and an end part of the second laminate film portion are overlaid and inner surfaces thereof are fused together. The fused part has an acute angle bent part that is bent in an angular shape or an arcuate shape to form an angle of less than 90°, and includes, in a region further toward a leading end of the fused part than the acute angle bent part, a leading end side region that is redirected away from a direction of bending in the acute angle bent part.

### CROSS-REFERENCE TO RELATED APPLICATION

This application is based on and claims priority under 35 USC 119 from Japanese Patent Application No. 2023-108903, filed on Jun. 30, 2023, the disclosure of which is incorporated by reference herein.

### TECHNICAL FIELD

The present disclosure relates to a laminated battery and a method of producing a laminated battery.

### RELATED ART

In a laminated battery in which an electrode body is covered with a laminate film, a part of the laminate film is fused to form a fused part, in order to enclose the electrode body. Further, the fused part is bent in order to improve the structural efficiency of the battery.

For example, Japanese Patent Application Laid-open No. 2019-200973 discloses a method of producing a secondary battery having a bent part at at least one end part of an exterior body that has been subjected to lamination, the method including a process of abutting a holding plate against a base point of bending of an end part of the exterior body; and after the abutting process, a process in which the holding plate and a presser plate disposed at a position opposing the holding plate so as to sandwich the end part therebetween are allowed to slide, thereby bending the end part around the base point and forming a bent part by holding the end part between the holding plate and the presser plate; in this method, the surfaces of the presser plate that slide on the end part include an inclined surface for bending the end part and a nipping surface for nipping the end part, and, further, the inclined surface, in a cross-section orthogonal to the width direction of the presser plate, is inclined such that the cross-sectional area of the presser plate narrows as it progresses in the sliding direction, and the inclined surface is also inclined relative to the width direction.

### SUMMARY OF THE INVENTION

### Problem to be Solved by the Invention

In order to improve the structural efficiency of a laminated battery, a technique has been employed in which a portion at which a laminate film is fused is bent to form an angle of 90° or less, thereby forming a bent part and reducing the size of the outer shape of the laminated battery as a whole. However, there have been cases in which spring-back occurs in the bent part, as a result of which the bent part becomes to form an angle greater than 90°, thus increasing the size of the outer shape of the laminated battery and decreasing the volume efficiency.

The present disclosure has been made in view of the above circumstances, and addresses provision of a laminated battery in which reduction in structural efficiency can be curbed, and a method of producing the laminated battery.

Aspects according to the present disclosure for providing the laminated battery and the method include the following aspects.
<1> A laminated battery, including:
an electrode body; and
a laminate film package that covers the electrode body and encloses the electrode body therein, in which:
the laminate film package includes a first laminate film portion and a second laminate film portion, and the laminate film package has a fused part at which an end part of the first laminate film portion and an end part of the second laminate film portion are overlaid and inner surfaces thereof are fused together, and
the fused part includes an acute angle bent part that is bent in an angular shape or an arcuate shape to form an angle of less than 90°, and includes, in a region further toward a leading end of the fused part than the acute angle bent part, a leading end side region that is redirected away from a direction of bending in the acute angle bent part.
<2> The laminated battery according to <1>, in which the angle of the acute angle bent part is from 30° to 75°.
<3> A method of producing a laminated battery including an electrode body and a laminate film package that covers the electrode body and encloses the electrode body therein, the laminate film package including a first laminate film portion and a second laminate film portion, and the laminate film package having a fused part at which an end part of the first laminate film portion and an end part of the second laminate film portion are overlaid and inner surfaces thereof are fused together, the method including:
a bending process of pressing a rotating fulcrum roll member having a disc shape against the fused part and bending the fused part to form an angle of less than 90° with a place at which the fulcrum roll member is pressed corresponding to a fulcrum, to form an acute angle bent part, the fulcrum roll member having a protrusion disposed in a circumferential direction at an outer peripheral part of the disc shape on a side that contacts the fused part.
<4> The method of producing a laminated battery according to <3>, in which the bending process includes bending the fused part while pressing an elastic roll against a portion of the fused part at which the acute angle bent part is to be formed, from an opposite side from the side that the protrusion of the fulcrum roll member contacts.
<5> The method of producing a laminated battery according to <3> or <4>, in which an angle of the tip of the protrusion is from 20° to 45°.

According to the present disclosure, a laminated battery in which reduction in structural efficiency can be curbed, and a method of producing the laminated battery, can be provided.

### BRIEF DESCRIPTION OF DRAWINGS

FIG. 1 is a schematic cross-sectional view illustrating an aspect of a laminated battery according to the present disclosure.

FIG. 2 is a schematic cross-sectional view showing the angles of portions in the fused part of the laminate film package of the aspect of the laminated battery according to the present disclosure.

FIG. 3 is a schematic cross-sectional view illustrating another aspect of the laminated battery according to the present disclosure.

FIG. 4 is a schematic cross-sectional view illustrating an aspect of a method of producing a laminated battery according to the present disclosure.

FIG. 5 is a schematic cross-sectional view showing the angles of portions of the protrusion of the fulcrum roll member used in the aspect of the method of producing a laminated battery according to the present disclosure.

FIG. 6 is a schematic cross-sectional view showing an example of a solid-state battery.

### MODES FOR CARRYING OUT INVENTION

### Laminated Battery

A laminated battery according to an embodiment of the present disclosure includes an electrode body and a laminate film package that covers the electrode body and encloses the electrode body inside the laminate film package, the laminate film package includes a first laminate film portion and a second laminate film portion, and the laminate film package has a fused part at which an end part of the first laminate film portion and an end part of the second laminate film portion are overlaid and inner surfaces thereof are fused together. Further, the fused part includes an acute angle bent part bent that is bent in an angular shape or an arcuate shape to form an angle of less than 90°, and includes, in a region further toward a leading end of the fused part than the acute-angle bent part, a leading end side region that is redirected away from the direction of bending in the acute angle bent part.

Hereinafter, this embodiment of the laminated battery according to the present disclosure is described with reference to the drawings.

The drawings are schematically represented, and the sizes and shapes of the parts are exaggerated as appropriate for case of understanding.

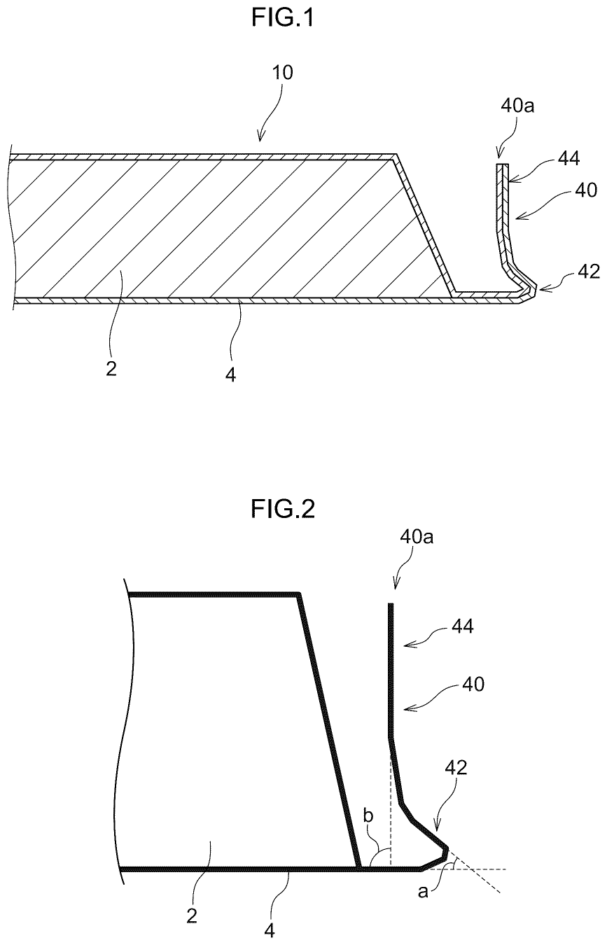

FIG. 1 is a schematic cross-sectional view illustrating a laminated battery according to the present embodiment.

A laminated battery 10 shown in FIG. 1 includes an electrode body 2 and a laminate film package 4 that covers the electrode body 2 and encloses the electrode body 2 therein. The laminate film package 4 includes a first laminate film portion (located at the upper side in FIG. 1) and a second laminate film portion (located at the lower side in FIG. 1). The laminate film package 4 includes a fused part 40 at which an end part of the first laminate film portion and an end part of the second laminate film portion are overlaid and inner surfaces thereof are fused together. Further, the fused part 40 includes an acute angle bent part 42 bent in an angular shape or an arcuate shape to form an angle of less than 90°. The fused part 40 further includes, in a region further toward a leading end 40a of the fused part 40 than the acute angle bent part 42, a leading end side region 44 that is redirected away from a direction of bending in the acute angle bent part 42.

According to the laminated battery 10 having the above configuration, reduction in the structural efficiency of the laminated battery 10 due to spring-back in the acute angle bent part 42 of the fused part 40 is curbed. We surmise that the reason that this effect can be exerted is as follows.

First, what happens in the case of a conventional laminated battery is described. Conventionally, in order to improve the structural efficiency of a laminated battery, a technique has been employed in which a fused part of a laminate film is bent to form an angle of 90° or less to form a bent part, thereby decreasing the size of the outer shape of the laminated battery as a whole. However, there have been cases in which spring-back occurs in the bent part, as a result of which the bent part becomes to have an angle greater than 90°, thus increasing the size of the outer shape of the laminated battery increases and decreasing the volume efficiency.

In contrast, in the laminated battery 10 according to the present embodiment, the acute angle bent part 42 that is bent to form an angle of less than 90° is provided in the fused part 40, and a shape of the leading end side region 44 closer to the leading end 40a than the acute angle bent part 42 is redirected away from the bending direction of the acute angle bent part 42. More specifically, a direction in which the fused part 40 extends from the acute angle bent part 42 to the root of the fused part 40 (i.e., the end of the fused part 40 at the electrode body 2 side) and a direction in which a region (hereinafter also referred to as “region B”) of the fused part 40 closer to the leading end 40a than the acute angle bent part 42 extends from the acute angle bent part 42, form an angle of less than 90°. Here, a region of the fused part 40 ranging from the root of the fused part 40 to the acute angle bent part 42 is hereinafter also referred to as “region A”. The direction in which the region B extends from the acute angle bent part 42 is a direction corresponding to a direction obtained by rotating the direction in which the region A extends from the root of the fused part 40 counterclockwise (in the case of FIG. 1) more than 90° to 180°. The region B is connected to the leading end side region 44. The direction in which the leading end side region 44 extends from the root at the region B side is a direction corresponding to a direction obtained by rotating the direction in which the region B extends from the acute angle bent part 42 in a rotation direction (i.e., clockwise in the case of FIG. 1) opposite to the rotation direction (i.e., counterclockwise in the case of FIG. 1) at the acute angle bent part 42. Here, the rotation direction refers to the rotation direction with respect to a rotation angle of 180° or less (rather than a reflex angle). Therefore, even though bending is performed such that the angle formed by the region A and the region B becomes so small as to be less than 90°, the leading end side region 44 can be prevented from hitting the electrode body portion. Thus, the acute angle bent part 42 is bent to a sufficient degree, thereby avoiding the occurrence of spring-back.

As a result, according to the laminated battery of the present embodiment of the present disclosure, reduction in the structural efficiency of the laminated battery due to spring-back at the acute angle bent part of the fused part can be curbed.

### Angles of Portions in the Fused Part

Preferred angles of portions in the fused part of the laminate film package in the laminated battery according to the present embodiment of the present disclosure are described.

The angle of the acute angle bent part that is bent in an angular or arcuate shape (angle a shown in FIG. 2) may be any angle that is less than 90°, and from the viewpoint of curbing reduction in the structural efficiency of the laminated battery, is preferably 75° or less, and more preferably 60° or less. Further, the lower limit value of the angle of the acute angle bent part is preferably 30° or more from the viewpoint of curbing reduction of the structural efficiency of the laminated battery, and is more preferably 40° or more. The angle of the acute angle bent part is preferably from 30° to 75°, and is more preferably from 40° to 60°.

Note that the angle of the acute angle bent part means the angle a shown in FIG. 2. In other words, the angle of the acute angle bent part means an angle formed by a direction in which the fused part 40 extends from the acute angle bent part 42 to the root of the fused part 40 (i.e., the end of the fused part 40 at the electrode body 2 side), and a direction in which a region (i.e., the foregoing region B) of the fused part 40 closer to the leading end 40a than the acute angle bent part 42 extends from the acute angle bent part 42.

The acute angle bent part has a shape bent in an angular shape or an arcuate shape. Angular means a shape having a corner, and arcuate means a curved shape having no corner.

The angle (angle b shown in FIG. 2) of the leading end side region, which is located in a region of the fused part closer to the leading end than the acute angle bent portion and which is redirected away from the bending direction of the acute angle bent portion, is preferably 95° or less, and is more preferably 90° or less, from the viewpoint of curbing reduction in the structural efficiency of the laminated battery. Further, the lower limit of the angle of the leading end side region is preferably 80° or more, and more preferably 85° or more, from the viewpoint of avoiding collision against the electrode body portion. The angle of the leading end side region is preferably from 80° to 95°, and is more preferably from 85° to 90°.

Note that the angle of the leading end side region of the fused part which is redirected away from the bending direction of the acute angle bent portion means the angle b shown in FIG. 2. In other words, the angle of the leading end side region that is redirected away from the bending direction of the acute angle bent portion means an angle formed by a direction in which the fused part 40 extends from the acute angle bent part 42 to the root of the fused part 40 (i.e., the end of the fused part 40 at the electrode body 2 side), and the direction in which the leading end side region 44, which is redirected away from the bending direction of the acute angle bent part 42 of the fused part 40, extends.

### Other Aspects

The fused part may have one or more other bent parts in addition to the acute angle bent part.

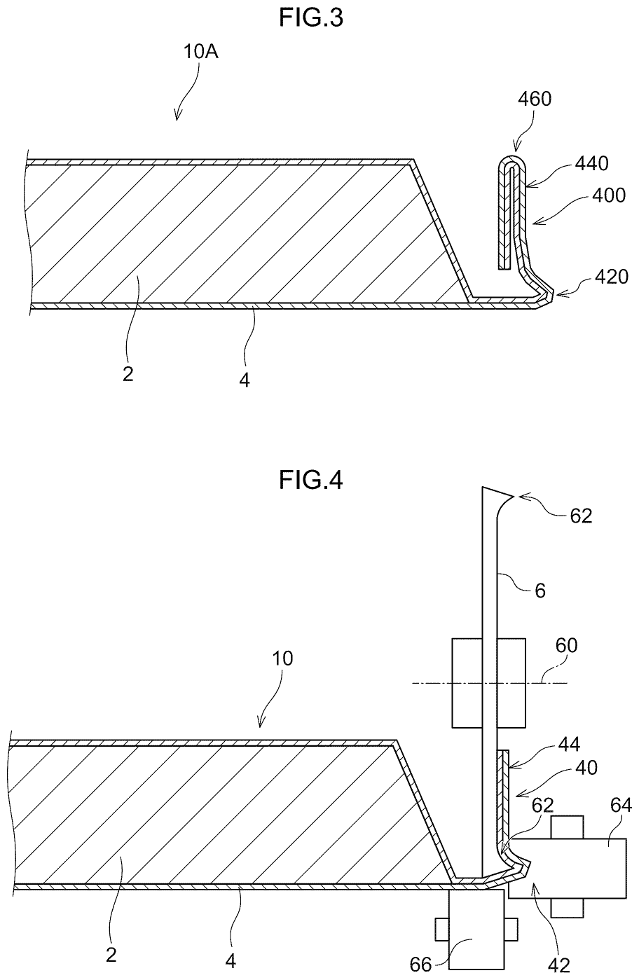

FIG. 3 is a schematic cross-sectional view illustrating another aspect of the laminated battery according to the present embodiment.

The laminated battery 10A shown in FIG. 3 includes an electrode body 2 and a laminate film package 4 that covers the electrode body 2 and encloses the electrode body 2 therein. The laminate film package 4 includes a first laminate film portion (located at the upper side in FIG. 3) and a second laminate film portion (located at the lower side in FIG. 3). The laminate film package 4 includes a fused part 400 at which an end part of the first laminate film portion and an end part of the second laminate film portion are overlaid and inner surfaces thereof are fused together. The fused part 400 includes an acute angle bent part 420 bent in an angular shape or an arcuate shape to form an angle of less than 90°. The fused part 400 further includes, in a region further toward the leading end side of the fused part 400 than the acute angle bent part 420, a leading end side region 440 that is redirected away from the bending direction of the acute angle bent part 420. Further, the fused part 400 has, in the leading end side region 440, a bent part 460 that is bent in an angular or arcuate shape to form an angle of approximately 0°, and has a shape such that the leading end side region 440 of the fused part 400 is folded back on itself. As a result, in the laminated battery 10A shown in FIG. 3, two bent parts (an acute angle bent part 420 and a bent part 460) are provided in the fused part package 400 of the laminate film 4. The leading end side region 440 having the bent part 460 forms a substantially integrated structure, and is included in the scope of the “leading end side region that is redirected away from the bending direction of the acute angle bent part” even though the leading end side region 440 has the bent part 460.

### Method of Producing Laminated Battery

Next, a method of producing a laminated battery according to an embodiment of the present disclosure is described.

A method of producing a laminated battery according to an embodiment of the present disclosure is a method of producing a laminated battery that includes an electrode body and a laminate film package that covers the electrode body and encloses the electrode body therein, the laminate film package including a first laminate film portion and a second laminate film portion, and the laminate film package having a fused part at which an end part of the first laminate film portion and an end part of the second laminate film portion are overlaid and inner surfaces thereof are fused together.

The method of producing a laminated battery has a bending process of pressing a rotating fulcrum roll member having a disc shape against the fused part and bending the fused part to form an angle of less than 90° with a place at which the fulcrum roll member is pressed corresponding to a fulcrum, to form an acute angle bent part. Further, the fulcrum roll member has a protrusion disposed in the circumferential direction (preferably continuously) at an outer peripheral part of the disc shape on a side that contacts the fused part.

Hereinafter, an embodiment of the method of producing a laminated battery according to the present disclosure is described with reference to the drawings. FIG. 4 is a schematic cross-sectional view illustrating the method of producing a laminated battery according to the present embodiment.

The laminated battery 10 shown in FIG. 4 includes an electrode body 2 and a laminate film package 4 that covers the electrode body 2 and encloses the electrode body 2 therein. The laminate film package 4 includes a first laminate film portion and a second laminate film portion. The laminate film package 4 has a fused part 40 at which an end part of the first laminate film portion and an end part of the second laminate film portion are overlaid and inner surfaces thereof are fused together.

The method of producing a laminated battery includes a bending process in which an acute angle bent part 42 is formed at the fused part 40 of the laminate film package 4. In the bending process, a disc-shaped fulcrum roll member 6, which rotates about a shaft 60, is pressed against the fused part 40, in which no acute angle bent part has been formed. The acute angle bent part 42 is formed by bending the fused part 40 so that an angle of less than 90° is formed, with the place at which the fulcrum roll member 6 is pressed corresponding to a fulcrum. The fulcrum roll member 6 has a protrusion 62 at a peripheral part of the disc shape on a side that contacts the fused part 40. The protrusion 62 is disposed continuously in the circumferential direction at an outer peripheral part of the disc shape of the fulcrum roll member 6.

As shown in FIG. 4, as a result of bending the fused part 40 while pressing thereagainst the fulcrum roll member 6 having the protrusion 62 at its end part, an acute angle bent part 42 having an angle of less than 90° can be formed even if the fulcrum roll member 6 in a standing state is pressed against the fused part 40.

If an acute angle bent part having an angle of less than 90° is to be formed in the fused part of the laminate film package using a fulcrum roll member having no protrusion at its end part, it would be necessary to incline the fulcrum roll member and press the inclined fulcrum roll member against the fused part. In this case, space for enabling the fulcrum roll member to be inclined would be required, which, in turn, would increase the distance from the electrode body to the acute angle bent part, as a result of which the structural efficiency of the battery decreases.

However, in a case in which the acute angle bent part 42 is formed using the fulcrum roll member 6 having the protrusion 62 at its peripheral part, it is not necessary to incline the fulcrum roll member 6, and, therefore, the distance from the electrode body 2 to the acute angle bent part 42 can be reduced. That is, by providing the protrusion 62 on the fulcrum roll member 6 and bending the fused part 40 using the fulcrum roll member 6, the acute angle bent part 42 having an angle of less than 90° can be formed even in a narrow space. As a result, the structural efficiency of the battery can be improved.

Furthermore, an elastic roll 64, of which surface that is to be contacted with the fused part is formed of an elastic member (for example, rubber), is pressed against a position of the fused part 40 at which the acute angle bent part 42 is to be formed, from the opposite side to the side contacted with the protrusion 62 of the fulcrum roll member 6. By performing bending while pressing the elastic roll 64 against a position opposed to the protrusion 42 of the fulcrum roll member 6, with a portion of the fused part 40 where the acute angle bent part 42 is to be formed disposed between the elastic roll 64 and the protrusion 62, it becomes possible to form the acute angle bent part 42 while applying a high pressure, and thereby enabling further reduction of the occurrence of spring back in the acute angle bent part 42 after the formation of the acute angle bent part 42.

Furthermore, at a position of the fused part 40 that is further toward the root side (i.e., at a position of the fused part 40 that is further toward the electrode body 2) than the portion at which the acute angle bent part 42 is to be formed, an opposing roll 66 is pressed against a position opposed to the fulcrum roll member 6 with the fused part 40 interposed therebetween.

### Angles of Portions in the Protrusion

Next, preferred angles of portions in the protrusion of the fulcrum roll member used in the method of producing a laminated battery according to the embodiment of the present disclosure are described.

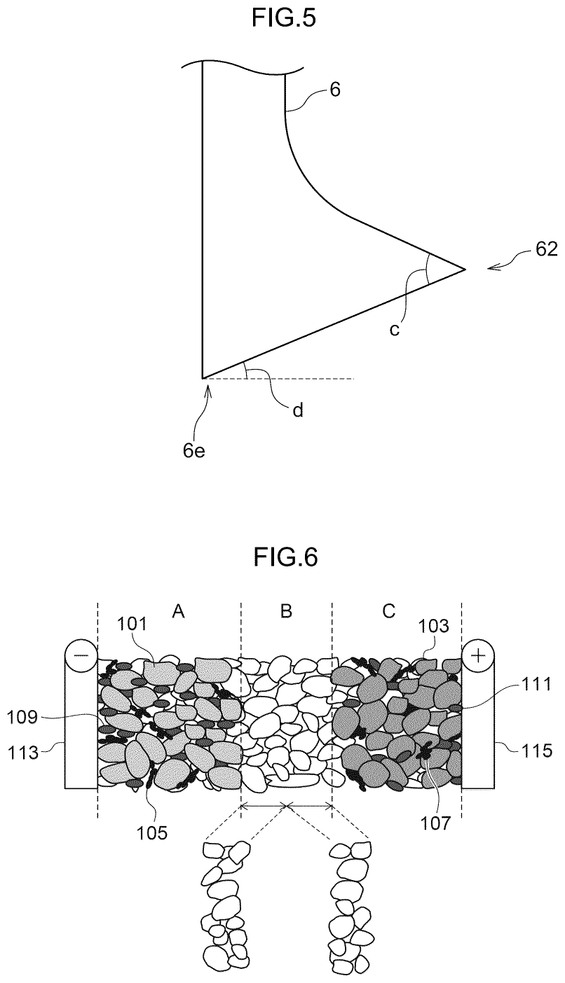

From the viewpoint of curbing reduction in the structural efficiency of the laminated battery, the angle of the tip of the protrusion (angle c shown in FIG. 5) is preferably 45° or less, and is more preferably 40° or less. Further, from the viewpoint of curbing reduction in the structural efficiency of the laminated battery, the lower limit value of the angle of the tip of the protrusion is preferably 20° or more, and is more preferably 25° or more. The angle of the tip of the protrusion is preferably from 20° to 45°, and is more preferably from 25° to 40°.

Note that the angle of the tip of the protrusion means the angle c shown in FIG. 5. In other words, the angle of the tip of the protrusion means the angle of the pointed tip part of the protrusion 62 of the fulcrum roll member 6.

From the viewpoint of curbing reduction in the structural efficiency of the laminated battery, the angle of the direction from the outer periphery of the disc shape of the fulcrum roll member toward the tip of the protrusion (angle d shown in FIG. 5) is preferably 45° or less, and is more preferably 40° or less. Further, from the viewpoint of curbing reduction in the structural efficiency of the laminated battery, the lower limit value of the angle of the direction from the outer periphery of the disc shape of the fulcrum roll member toward the tip of the protrusion is preferably 20° or more, and is more preferably 25° or more. The angle is preferably from 20° to 45°, and is more preferably from 25° to 40°.

Note that the angle of the direction from the outer periphery of the disc shape of the fulcrum roll member toward the tip of the protrusion means the angle d shown in FIG. 5. In other words, the angle of the direction from the outer periphery of the disc shape of the fulcrum roll member toward the tip of the protrusion means an angle formed between the direction from an outer periphery 6e of the disc shape of the fulcrum roll member 6 toward the tip of the protrusion 62, and a direction normal to disc plane of the fulcrum roll member 6.

### (Battery Members)

Next, the electrode body and the laminate film package configuring the laminated battery according to the present embodiment are described.

### (1) Laminate Film

As the laminate film (including the first laminate film portion and the second laminate film portion) in the laminate film package, a film having a three-layer structure having a metal layer, a protective resin layer on the outer side of the metal layer, and a fused resin layer on the inner side of the metal layer is used, for example.

Examples of the material of the fused resin layer include olefinic resins such as polypropylene (PP) and polyethylene (PE). Examples of the material of the metal layer include aluminum, an aluminum alloy, and stainless steel. Examples of the material of the protective resin layer include polyethylene terephthalate (PET) and nylon. The thickness of the fused resin layer is, for example, from 40 μm to 100 μm. The thickness of the metal layer is, for example, from 30 μm to 60 μm. The thickness of the protective resin layer is, for example, from 20 μm to 60 μm. The thickness of the entire laminate film is, for example, from 70 μm to 220 μm.

### (2) Electrode Body

The electrode body functions as a power generation element of the battery. The electrode body usually includes a positive electrode current collector, a positive electrode active material layer, an electrolyte layer, a negative electrode active material layer, and a negative electrode current collector in this order in the thickness direction.

The positive electrode active material layer contains at least a positive electrode active material. The positive electrode active material layer may further contain at least one of a conductive material, an electrolyte, or a binder. The form of the positive electrode active material is, for example, particulate. Examples of the positive electrode active material include oxide active materials. Furthermore, sulfur (S) may be used as the positive electrode active material.

The positive electrode active material preferably contains a lithium composite oxide. The lithium composite oxide may contain at least one selected from the group consisting of F, Cl, N, S, Br and I. Furthermore, the lithium composite oxide may have a crystalline structure belonging to at least one space group selected from the space groups R-3m, Immm, and P63-mmc (also referred to as P63mc, P6/mmc). Furthermore, in the lithium composite oxide, the main arrangement of a transition metal, oxygen, and lithium may have an O2-type structure.

Examples of the lithium composite oxide having a crystal structure belonging to R-3m include a compound represented by LiₓMe_{y}O_{α}X_{β} (in which Me represents at least one selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si, and P, X represents at least one selected from the group consisting of F, CI, N, S, Br and I, and x, y, α and β satisfy 0.5≤x≤1.5, 0.5≤y≤1.0, 1≤α<2, and 0<β≤1).

Examples of the lithium composite oxide having a crystal structure belonging to Immm include a composite oxide represented by Liₓ₁M¹A¹₂ (specifically, for example, Li₂NiO₂) (in which x1 satisfies 1.5≤x1≤2.3, M¹ includes at least one selected from the group consisting of Ni, Co, Mn, Cu and Fe, A¹ includes at least oxygen, and the proportion of oxygen in A¹ is 85 atomic % or more), and a composite oxide represented by Liₓ₁M^{1A}₁₋ₓ₂M^{1B}ₓ₂O_{2-y}A²_{y} (where x2 and y satisfy 0≤x2≤0.5 and 0≤y≤0.3, at least one of x2 or y is not 0, M^{1A} represents at least one selected from the group consisting of Ni, Co, Mn, Cu and Fe, M^{1B} represents at least one selected from the group consisting of Al, Mg, Sc, Ti, Cr, V, Zn, Ga, Zr, Mo, Nb, Ta and W, and A2 represents at least one selected from the group consisting of F, Cl, Br, S and P).

Examples of the lithium composite oxide having a crystal structure belonging to P63-mmc include a composite oxide represented by M1ₓM2_{y}O₂ (where M1 represents an alkali metal (preferably at least one of Na or K), M2 represents a transition metal (preferably at least one selected from the group consisting of Mn, Ni, Co and Fe), and x+y satisfies 0<x+y≤2).

Examples of lithium composite oxides having an O2-type structure include a composite oxide represented by Liₓ[Li_{α}(MnₐCo_{b}M_{c})_{1-α}]O₂ (where 0.5<x<1.1, 0.1<α<0.33, 0.17<a<0.93, 0.03<b<0.50, 0.04<c<0.33, and M represents at least one selected from the group consisting of Ni, Mg, Ti, Fe, Sn, Zr, Nb, Mo, W and Bi), and specific examples thereof include Li_{0.744}[Li_{0.145}Mn_{0.625}Co_{0.115}Ni_{0.115}]O₂.

Furthermore, the positive electrode preferably contains, in addition to the positive electrode active material, a solid electrolyte selected from the group consisting of sulfide solid electrolytes, oxide solid electrolytes, and halide solid electrolytes. In a more preferable aspect, at least a part of the surface of the positive electrode active material is coated with a sulfide solid electrolyte, an oxide solid electrolyte, or a halide solid electrolyte. As the halide solid electrolyte covering at least a part of the surface of the positive electrode active material, Li_{6-(4-x)b}(Ti₁₋ₓAlₓ)_{b}F₆ (in which x and b satisfy 0<x<1, and 0<b≤1.5) (LTAF electrolyte) is preferable.

Examples of the conductive material include carbon materials. The electrolyte may be a solid electrolyte or may be a liquid electrolyte. The solid electrolyte may be an organic solid electrolyte such as a gel electrolyte, or may be an inorganic solid electrolyte such as an oxide solid electrolyte or a sulfide solid electrolyte. Furthermore, the liquid electrolyte (in other words, an electrolytic solution) contains, for example, a supporting salt such as a LiPF₆ and a solvent such as a carbonate-based solvent. Examples of the binder include rubber-based binders and fluoride-based binders.

The negative electrode active material layer contains at least a negative electrode active material. The negative electrode active material layer may further contain at least one of a conductive material, an electrolyte, or a binder. Examples of the negative electrode active material include metal active materials such as Li and Si, carbon active materials such as graphite, and oxide active materials such as Li₄Ti₅O₁₂. The form of the negative electrode current collector is, for example, foil-shaped or mesh-shaped. The conductive material, the specifics of the electrolyte, and the binder are the same as those described above.

The electrolyte layer is arranged between the positive electrode active material layer and the negative electrode active material layer and contains at least an electrolyte. The electrolyte may be a solid electrolyte or may be a liquid electrolyte. The electrolyte layer is preferably a solid electrolyte layer. The electrolyte layer may have a separator.

The solid electrolyte preferably contains at least one solid electrolyte species selected from the solid electrolyte group consisting of a sulfide solid electrolyte, an oxide solid electrolyte, and a halide solid electrolyte.

The sulfide solid electrolyte preferably contains sulfur(S) as the main anion element, and preferably further contains, for example, Li element, clement A, and S element. The element A is at least one selected from the group consisting of P, As, Sb, Si, Ge, Sn, B, Al, Ga, and In. The sulfide solid electrolyte may further contain at least one of O or a halogen element. Examples of the halogen element (X) include F, Cl, Br, and I. The composition of the sulfide solid electrolyte is not particularly limited, and examples thereof include xLi₂S·(100-x)P₂S₅ (70≤x≤80), and yLiI·zLiBr·(100-y-z)(xLi₂S·(1-x)P₂S₅)(0.7≤x≤0.8, 0≤y≤30, 0≤z≤30). The sulfide solid electrolyte may have a composition represented by the following Formula (1).

Li₄₋ₓGe₁₋ₓPₓS₄ (0<x<1) Formula (1)

In Formula (1), at least a part of Ge may be substituted with at least one selected from the group consisting of Sb, Si, Sn, B, Al, Ga, In, Ti, Zr, V and Nb. Furthermore, at least a part of P may be substituted with at least one selected from the group consisting of Sb, Si, Sn, B, Al, Ga, In, Ti, Zr, V and Nb. A part of Li may be substituted with at least one selected from the group consisting of Na, K, Mg, Ca and Zn. A part of S may be substituted with a halogen. The halogen is at least one of F, Cl, Br, or I.

The oxide solid electrolyte preferably contains oxygen (O) as the main anionic element, and may contain, for example, Li, an element Q (Q representing at least one of Nb, B, Al, Si, P, Ti, Zr, Mo, W or S) and O. Examples of the oxide solid electrolyte include garnet-type solid electrolytes, perovskite-type solid electrolytes, NASICON-type solid electrolytes, Li—P—O-based solid electrolytes, and Li—B—O-based solid electrolytes. Examples of garnet-type solid electrolytes include Li₇La₃Zr₂O₁₂, Li₇₋ₓLa₃(Zr₂₋ₓNbₓ)O₁₂ (0≤x≤2), and Li₅La₃Nb₂O₁₂. Examples of perovskite-type solid electrolytes include (Li,La)TiO₃, (Li,La)NbO₃, and (Li,Sr)(Ta,Zr)O₃. Examples of NASICON-type solid electrolytes include Li(Al,Ti)(PO₄)₃, and Li(Al,Ga)(PO₄)₃. Examples of Li—P—O-based solid electrolytes include Li₃PO₄, and LIPON (a compound obtained by replacing a part of O in Li₃PO₄ by N), and examples of Li—B—O-based solid electrolytes include Li₃BO₃, and compounds obtained by replacing a part of O in Li₃BO₃ by C.

As the halide solid electrolyte, solid electrolytes containing Li, M and X (M representing at least one of Ti, Al or Y, and X representing F, Cl or Br) are suitable. Specifically, Li_{6-3z}Y_{z}X₆ (X representing Cl or Br, and z satisfying 0<z<2), and Li_{6-(4-x)b}(Ti₁₋ₓAlₓ)_{b}F₆ (0<x<1, 0<b≤1.5) are preferable. Among Li_{6-3z}Y_{z}X₆, Li₃YX₆ (X representing Cl or Br) is more preferred, and Li₃YCl₆ is even more preferable, from the viewpoint that such materials have excellent lithium ion conductivity. Furthermore, from viewpoints such as of reducing oxidative decomposition of sulfide solid-electrolytes, it is preferable that Li_{6-(4-x)b}(Ti₁₋ₓAlₓ)_{b}F₆ (0<x<1, 0<b≤1.5) is contained together with a solid electrolyte such as a sulfide solid electrolyte.

The positive electrode current collector performs electric current collection for the positive electrode active material layer. Examples of the positive electrode current collector include stainless steel, aluminum, nickel, iron, titanium, and carbon, among which aluminum alloy foil or aluminum foil is preferable. The aluminum alloy foil and the aluminum foil may be produced using a powder. The form of the positive electrode current collector is, for example, foil-shaped or mesh-shaped.

The negative electrode current collector performs electric current collection for the negative electrode active material layer. Examples of the material of the negative electrode current collector include metals such as copper, SUS, and nickel. Examples of the form of the negative electrode current collector include foil-shaped and mesh-shaped.

### Battery Structure

The structure of a solid-state battery includes a layered structure of positive electrode/solid electrolyte layer/negative electrode. Solid-state batteries include so-called all-solid-state batteries in which a solid electrolyte is used as an electrolyte, and the solid electrolyte may contain less than 10% by mass of an electrolytic solution relative to the total amount of the electrolyte. Note that the solid electrolyte may be a composite solid electrolyte containing an inorganic solid electrolyte and a polymer electrolyte.

The positive electrode includes a positive electrode active material layer and a current collector, and the negative electrode includes a negative electrode active material layer and a current collector.

The solid electrolyte layer may have a single-layer structure or a multilayer structure of two or more layers.

The solid-state battery may have, for example, the cross-sectional structure shown in FIG. 6, and a solid electrolyte layer B may have a two-layer structure as shown in FIG. 6. FIG. 6 schematically shows a cross-sectional view of an example of a solid-state battery. The solid-state battery shown in FIG. 6 has a negative electrode including a negative electrode current collector 113 and a negative electrode active material layer A, a solid electrolyte layer B, and a positive electrode including a positive electrode current collector 115 and a positive electrode active material layer C. The negative electrode active material layer A contains a negative electrode active material 101, a conductive aid 105, and a binder 109. The positive electrode active material layer C contains a coated positive electrode active material 103, a conductive aid 107, and a binder 111. In the coated positive electrode active material 103, the surface of the positive electrode active material is coated with an LTAF electrolyte or a LiNbO₃ electrolyte.

Furthermore, the solid-state battery may be configured by sealing stack edge faces (side faces) of a stacked structure of the positive electrode/the solid electrolyte layer/the negative electrode with a resin. The current collector of the electrode may have a configuration in which a buffer layer, an elastic layer, or a positive temperature coefficient (PTC) thermistor layer is disposed on the surface thereof.

### Battery

The laminated battery according to the present disclosure is typically a lithium ion secondary battery. Examples of the use of the battery include power sources of vehicles such as hybrid vehicles (HEVs), plug-in hybrid vehicles (PHEVs), battery electric vehicles (BEVs), gasoline-powered vehicles, and diesel-powered vehicles. In particular, the battery is preferably used as a power source for driving a hybrid vehicle (HEV), a plug-in hybrid vehicle (PHEV), or a battery electric vehicle (BEV). Furthermore, the battery according to the present disclosure may be used as a power source for a moving body other than a vehicle (for example, a train, a ship, or an aircraft), and may be used as a power source for an electrical product such as an information processing apparatus.

The present disclosure is not limited to the above embodiments. The above embodiments are illustrative, and embodiments having substantially the same configuration as the technical concepts recited in the claims of the present disclosure and exhibiting the same work mechanisms and effects are all encompassed by the technical scope of the present disclosure.

### EXPLANATION OF REFERENCE NUMERALS

Throughout the figures, the reference characters respectively represent the following elements.
2: electrode body
4: laminate film package
6: fulcrum roll member
10 and 10A: laminated battery
40 and 400: fused part
40a: leading end
42 and 420: acute angle bent part
44 and 440: leading end side region
460: bent part
60: shaft
62: protrusion
64: elastic roll
66: opposing roll
101: negative electrode active material
103: coated positive electrode active material
105 and 107: conductive aid
109 and 111: binder
113: negative electrode current collector
115: positive electrode current collector
A: negative electrode active material layer
B: solid electrolyte layer
C: positive electrode active material layer

1. A laminated battery, comprising:
an electrode body; and
a laminate film package that covers the electrode body and encloses the electrode body therein, wherein:
the laminate film package includes a first laminate film portion and a second laminate film portion, and the laminate film package has a fused part at which an end part of the first laminate film portion and an end part of the second laminate film portion are overlaid and inner surfaces thereof are fused together, and
the fused part includes an acute angle bent part that is bent in an angular shape or an arcuate shape to form an angle of less than 90°, and includes, in a region further toward a leading end of the fused part than the acute angle bent part, a leading end side region that is redirected away from a direction of bending in the acute angle bent part.

2. The laminated battery according to claim 1, wherein the angle of the acute angle bent part is from 30° to 75°.

3. A method of producing a laminated battery including an electrode body and a laminate film package that covers the electrode body and encloses the electrode body therein, the laminate film package including a first laminate film portion and a second laminate film portion, and the laminate film package having a fused part at which an end part of the first laminate film portion and an end part of the second laminate film portion are overlaid and inner surfaces thereof are fused together, the method comprising:
a bending process of pressing a rotating fulcrum roll member having a disc shape against the fused part and bending the fused part to form an angle of less than 90° with a place at which the fulcrum roll member is pressed corresponding to a fulcrum, to form an acute angle bent part,
wherein the fulcrum roll member has a protrusion disposed in a circumferential direction at an outer peripheral part of the disc shape on a side that contacts the fused part.

4. The method of producing a laminated battery according to claim 3, wherein the bending process comprises bending the fused part while pressing an elastic roll against a portion of the fused part at which the acute angle bent part is to be formed, from an opposite side from the side that the protrusion of the fulcrum roll member contacts.

5. The method of producing a laminated battery according to claim 3, wherein an angle of a tip of the protrusion is from 20° to 45°.

6. The method of producing a laminated battery according to claim 4, wherein an angle of a tip of the protrusion is from 20° to 45°.
